(19) United States
(12) Patent Application Publication
(10) Pub. No.: US 2026/0041024 A1
(43) Pub. Date: Feb. 12, 2026

(54) AGRICULTURAL NAVIGATION AND STEERING SYSTEMS, DEVICES AND METHODS

(71) Applicant: Ag Leader Technology, Ames, IA (US)

(72) Inventors: Nathan Risius, Huxley, IA (US); Kurt Larsen, Story City, IA (US)

(21) Appl. No.: 19/297,963

(22) Filed: Aug. 12, 2025

Related U.S. Application Data
(60) Provisional application No. 63/682,229, filed on Aug. 12, 2024.

(51) Int. Cl. A01B 69/04; A01D 41/127

(52) U.S. Cl. CPC A01B 69/008; A01D 41/1278

(57) ABSTRACT

An agricultural steering and navigation system comprising a tactile steering system comprising at least one crop sensor configured to command steering of an agricultural vehicle based upon the location of stalks, a GPS guidance system comprising at least one GPS receiver configured to command steering of the agricultural vehicle along guidance paths, and a processor configured for selectively using either the tactile steering system and the GPS guidance system based on one or more triggers.

### CROSS-REFERENCE TO RELATED APPLICATION(S)

This application claims the benefit under 35 U.S.C. § 119(e) to U.S. Provisional Application 63/682,229, filed Aug. 12, 2024, and entitled INTEGRATED CROP SENSOR AND GPS STEERING SYSTEMS AND RELATED DEVICES AND METHODS, which is hereby incorporated herein by reference in its entirety for all purposes.

### TECHNICAL FIELD

The disclosure relates to agricultural guidance and steering systems and related devices and methods.

### BACKGROUND

Various guidance systems are known in the art for automated and assisted steering of agricultural vehicles (e.g., combines, harvesters).

### BRIEF SUMMARY

Disclosed herein are various devices, systems, and methods for agricultural guidance and automated/assisted steering. The various implementations include an integrated system for use of crop sensors (e.g. tactile, radar, or vision sensors) and GPS guidance and the ability to seamlessly transition between the two types of guidance/steering for accurate and efficient guidance and navigation.

In Example 1, an agricultural steering system comprising: a tactile steering system comprising at least one crop sensor configured to command steering of an agricultural vehicle based upon the location of stalks; a GPS guidance system comprising at least one GPS receiver configured to command steering of the agricultural vehicle along guidance paths; and a processor configured for selectively using either the tactile steering system and the GPS guidance system based on one or more triggers.

Example 2 relates to the agricultural steering system of any of Examples 1 and 3-9, wherein the one or more triggers include detection of stalks entering the header by the at least one crop sensor, completing a pass, approaching/crossing a field boundary, and entering an already harvested area.

Example 3 relates to the agricultural steering system of any of Examples 1-2 and 4-9, wherein the system is configured to use the tactile steering system during active harvesting of crops and use the GPS guidance system when not actively harvesting crops.

Example 4 relates to the agricultural steering system of any of Examples 1-3 and 5-9, wherein the processor is configured to automatically switch between the tactile steering system and the GPS guidance system upon activation of the one or more triggers.

Example 5 relates to the agricultural steering system of any of Examples 1˜4 and 6-9, further comprising an automatic steering system wherein the processor is configured to command the automatic steering system.

Example 6 relates to the agricultural steering system of any of Examples 1-5 and 7-9, wherein the at least one crop sensor is one or more of a tactile steering sensor, a tactile crop sensor, a vision sensor, a radar sensor, a resilient member sensor, and a LIDAR sensor.

Example 7 relates to the agricultural steering system of any of Examples 1-6 and 8-9, wherein the at least one crop sensor is a tactile steering sensor.

Example 8 relates to the agricultural steering system of any of Examples 1-7 and 9, wherein the one or more triggers is active harvesting and wherein the system uses the tactile steering system during active harvesting and the GPS guidance based system when not actively harvesting.

Example 9 relates to the agricultural steering system of any of Examples 1-8, wherein active harvesting is determined by the at least one crop sensor sensing stalks entering the agricultural vehicle.

In Example 10, a system for automatic agricultural steering and navigation comprising at least one row unit for a harvester, comprising a first crop sensor; a global positioning system (GPS) receiver configured to be disposed on the harvester; an operations unit comprising a processor in communication with the first crop sensor and the GPS receiver, and an assisted steering system configured to command a vehicle to navigate a field, wherein the operations unit is configured to determine use of navigation based on inputs from the first crop sensor or navigation based on one or more guidance paths generated with inputs from the GPS receiver.

Example 11 relates to the system of any of Examples 10 and 12-17, wherein the harvester comprises a plurality of row units, each of the plurality of row units comprising the first crop sensor.

Example 12 relates to the system of any of Examples 10-11 and 13-17, wherein the first crop sensor is one or more of a tactile steering sensor, a tactile crop sensor, a vision sensor, a radar sensor, a resilient member sensor, and a LiDAR sensor.

Example 13 relates to the system of any of Examples 10-12 and 14-17, wherein the first crop sensor is a tactile steering sensor.

Example 14 relates to the system of any of Examples 10-13 and 15-17, further comprising a second crop sensor disposed on the at least one row unit wherein the second crop sensor is a tactile crop sensor.

Example 15 relates to the system of any of Examples 10-14 and 16-17, wherein the assisted steering system provides for autonomous navigation.

Example 16 relates to the system of any of Examples 10-15 and 17, wherein the operations used evaluates one or more triggers for switching between navigation based on inputs from the first crop sensor or navigation based on one or more guidance paths generated with inputs from the GPS receiver.

Example 17 relates to the system of any of Examples 10-16, wherein the one or more triggers include detection of stalks entering the header by the at least one crop sensor, completing a pass, approaching/crossing a field boundary, and entering an already harvested area

In Example 18 a method for agricultural navigation comprising: inputting a signal from at least one sensor disposed on a harvester the signal indicative of a relative position of the harvester within a row; obtaining a position from a GPS receiver on the harvester; generating a set of GPS based guidance paths; and selecting a first navigation mode based on the signal from the at least one sensor or a second navigation mode based on the GPS based guidance paths, wherein a automatic steering system can switch between the first navigation mode or the second navigation mode is based on one or more triggers.

Example 19 relates to the method of any of Examples 18 and 20, wherein the one or more triggers include detection of stalks entering the header by the at least one sensor, completing a pass, approaching/crossing a field boundary, and entering an already harvested area.

Example 20 relates to the method of any of Examples 18-19, wherein the at least one sensor is one or more of a tactile steering sensor, a tactile crop sensor, a vision sensor, a radar sensor, a resilient member sensor, and a LIDAR sensor.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is a schematic diagram of the system implemented on a combine, according to one implementation.

FIG. 2 is a system diagram, according to one implementation.

FIG. 3 is a top view of a crop and steering sensors on a harvester, according to one implementation.

FIG. 4 is a field diagram showing transitioning from sensor based steering to GPS based guidance, according to one implementation.

FIG. 5 is a field diagram showing sensor based steering, according to one implementation.

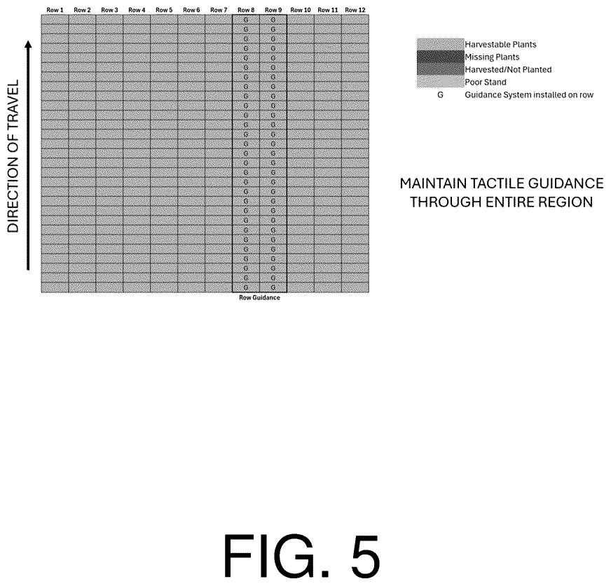

FIG. 6 is a field diagram showing transition points for transitioning between sensor based steering and GPS based guidance, according to one implementation.

FIG. 7 is a field diagram showing transition points for transitioning between sensor based steering and GPS based guidance, according to one implementation.

FIG. 8 is a field diagram showing transition points for transitioning between sensor based steering and GPS based guidance, according to one implementation.

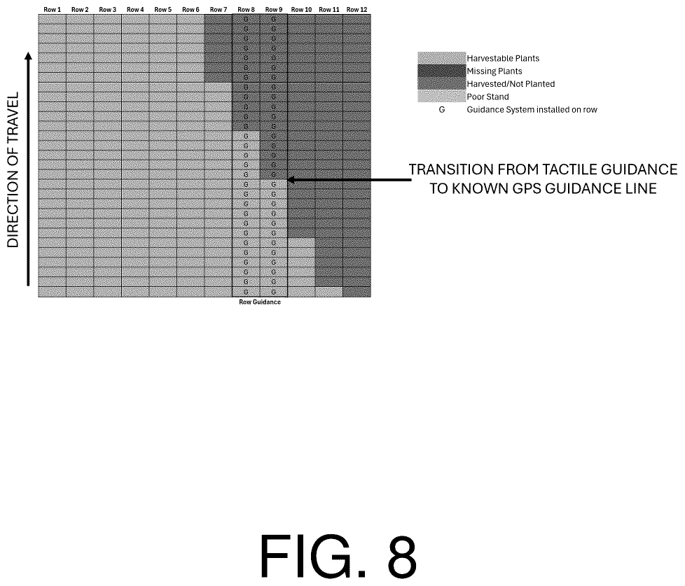

### DETAILED DESCRIPTION

Disclosed herein are various systems and related devices and methods that allow for an integrated steering system including both a crop sensor based steering and GPS guidance based steering. In various implementations, the integrated system allows for smart switching/transition between crop sensor steering and a GPS guidance system. That is, one or more triggers are programmed such that when the trigger is activated the integrated system selects the type of steering for the situation.

Various triggers for transitioning between crop sensor based steering and GPS guidance based steering may include: detecting the presence of stalks entering the header by a crop sensor; completing a pass, approaching/crossing a field boundary, entering an already harvested area, entering a region within a field with a poor stand, and others as would be appreciated.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. Pat. No. 11,277,961, issued Mar. 22, 2022, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 11,064,653, issued Jul. 20, 2021, entitled “Agricultural Systems Having Stalk Sensors and/or Data Visualization Systems and Related Devices and Methods,” U.S. Pat. No. 11,297,768, issued Apr. 12, 2022, entitled “Vision Based Stalk Sensors and Associated Systems and Methods,” U.S. patent application Ser. No. 17/013,037, filed Sep. 4, 2020, entitled “Apparatus, Systems and Methods for Stalk Sensing,” U.S. patent application Ser. No. 17/226,002 filed Apr. 8, 2021, and entitled “Apparatus, Systems and Methods for Stalk Sensing,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 15, 2019, entitled “On-The-Go Organic Matter Sensor and Associated Systems and Methods,” U.S. Pat. No. 11,523,554, issued Dec. 13, 2022, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. Pat. No. 11,678,607, issued Jun. 20, 2023, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. Pat. No. 11,785,881, issued Oct. 17, 2023, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. Pat. No. 11,877,530 issued Jan. 23, 2024, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/225,586, filed Apr. 8, 2021, entitled “Devices, Systems, and Methods for Corn Headers,” U.S. Pat. No. 11,758,848, issued Sep. 19, 2023, entitled “Devices, Systems, and Methods for Sensing the Cross Sectional Area of Stalks,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. patent application Ser. No. 17/461,839, filed Aug. 30, 2021, entitled “Automated Agricultural Implement Orientation Adjustment System and Related Devices and Methods,” U.S. patent application Ser. No. 17/468,535, filed Sep. 7, 2021, entitled “Apparatus, Systems, and Methods for Row-by-Row Control of a Harvester,” U.S. patent application Ser. No. 17/526,947, filed Nov. 15, 2021, entitled “Agricultural High Speed Row Unit,” U.S. patent application Ser. No. 17/566,506, filed Dec. 20, 2021, entitled “Devices, Systems, and Method For Seed Delivery Control,” U.S. patent application Ser. No. 17/576,463, filed Jan. 14, 2022, entitled “Apparatus, Systems, and Methods for Row Crop Headers,” U.S. patent application Ser. No. 17/724,120, filed Apr. 19, 2022, entitled “Automatic Steering Systems and Methods,” U.S. patent application Ser. No. 17/742,373, filed May 11, 2022, entitled “Calibration Adjustment for Automatic Steering Systems,” U.S. patent application Ser. No. 17/902,366, filed Sep. 2, 2022, entitled “Tile Installation System with Force Sensor and Related Devices and Methods,” U.S. patent application Ser. No. 17/939,779, filed Sep. 7, 2022, entitled “Row-by-Row Estimation System and Related Devices and Methods,” U.S. patent application Ser. No. 18/215,721, filed Jun. 28, 2023, entitled “Seed Tube Guard and Associated Systems and Methods of Use,” U.S. patent application Ser. No. 18/087,413, filed Dec. 22, 2022, entitled “Data Visualization and Analysis for Harvest Stand Counter and Related Systems and Methods,” U.S. patent application Ser. No. 18/097,804, filed Jan. 17, 2023, entitled “Agricultural Mapping and Related Systems and Methods,” U.S. patent application Ser. No. 18/101,394, filed Jan. 25, 2023, entitled “Seed Meter with Integral Mounting Method for Row Crop Planter and Associated Systems and Methods,” U.S. patent application Ser. No. 18/102,022, filed Jan. 26, 2023, entitled “Load Cell Backing Plate and Associated Devices, Systems, and Methods,” U.S. patent application Ser. No. 18/116,714, filed Mar. 2, 2023, entitled “Cross Track Error Sensor and Related Devices, Systems, and Methods,” U.S. patent application Ser. No. 18/203,206, filed May 30, 2023, entitled “Seed Tube Camera and Related Devices, Systems and Methods,” U.S. patent application Ser. No. 18/209,331, filed Jun. 13, 2023, entitled “Apparatus, Systems and Methods for Image Plant Counting,” U.S. patent application Ser. No. 18/217,216, filed Jun. 30, 2023, entitled “Combine Unloading On-The-Go with Bin Level Sharing and Associated Devices, Systems, and Methods,” U.S. patent application Ser. No. 18/229,974, filed Aug. 3, 2023, entitled “Hydraulic Cylinder Position Control for Lifting and Lowering Towed Implements,” U.S. patent application Ser. No. 18/230,534, filed Aug. 4, 2023, entitled “Single-Step Seed Placement in Furrow and Related Devices, Systems, and Methods,” U.S. patent application Ser. No. 18/238,344, filed Aug. 25, 2023, entitled “Combine Yield Monitor Automatic Calibration System and Associated Devices and Methods,” U.S. patent application Ser. No. 18/367,929, filed Sep. 13, 2023, entitled “Hopper Lid with Magnet Retention and Related Systems and Methods,” U.S. patent application Ser. No. 18/516,514, filed Nov. 21, 2023, entitled “Stalk Sensors and Related Devices, Systems, and Methods,” U.S. patent application Ser. No. 18/441,708, filed Feb. 14, 2024, entitled “Liquid Flow Meter and Flow Balancer and Associated Devices, Systems, and Methods,” U.S. patent application Ser. No. 18/662,800, filed May 13, 2024, entitled “Devices, Systems, and Methods for Providing Yield Maps,” U.S. patent application Ser. No. 18/665,305, filed May 15, 2024, entitled “Devices, Systems, and Methods for Agricultural Guidance and Navigation,” U.S. patent application Ser. No. 18/761,041, filed Jul. 1, 2024, entitled “Ring Assembly For Automatic and/or Assisted Steering and Associated Systems and Methods,” U.S. patent application Ser. No. 18/776,374, filed Jul. 8, 2024, entitled “Assisted Steering Systems and Associated Devices and Methods for Agricultural Vehicles,” U.S. patent application Ser. No. 18/929,309, filed Oct. 28, 2024, entitled “Agricultural Implement Position Sensor and Related Devices, Systems, and Methods,” U.S. patent application Ser. No. 18/962,799, filed Nov. 27, 2024, entitled “Devices, Systems and Methods for Guidance Line Shifting,” U.S. patent application Ser. No. 18/974,482, filed Dec. 9, 2024, entitled “Header Height Control Devices, Systems and Methods,” U.S. patent application Ser. No. 18/980,728, filed Dec. 13, 2024, entitled “Deck Plate Spacing Sensors and Related Devices, Systems, and Methods,” U.S. patent application Ser. No. 19/041,787, filed Jan. 30, 2025, entitled “Grain Cart Unloading Sensor and Unload Control System and Associated Devices and Methods,” U.S. patent application Ser. No. 19/207,115, filed May 13, 2025, entitled “Devices, Systems, and Methods for Planter and Seed Trench Imaging and Analysis,” U.S. patent application Ser. No. 19/219,718, fled May 27, 2025, entitled “Devices, Systems, and Methods for Agricultural Navigation and Positioning,” U.S. patent application Ser. No. 19/226,004, filed Jun. 2, 2025, entitled “Devices, Systems, and Methods for Machinery Monitoring and Reporting,” U.S. Patent Application 63/667,546, filed Jul. 3, 2024, entitled “Cover for Port Openings,” U.S. patent application Ser. No. 19/260,159, filed Jul. 3, 2025, entitled “Agricultural Seed Meters and Related Devices, Systems and Methods,” U.S. Patent Application 63/685,000, filed Aug. 20, 2024, entitled “Crop Sensor Wands and Related Devices, Systems, and Methods,” U.S. Patent Application 63/710,492, filed Oct. 22, 2024, entitled “Crop Sensors and Related Devices, Systems, and Methods,” U.S. Patent Application 63/710,641, filed Oct. 23, 2024, entitled “Agricultural Sprayer Boom Flush, Chemical Detection and Chemical Concentration Detection,” U.S. Patent Application 63/720,611, filed Nov. 14, 2024, entitled “Liquid Product Distribution for See and Spray Systems,” U.S. Patent Application 63/722,916, filed Nov. 20, 2024, entitled “Agricultural Harvesting Systems and Related Devices and Methods,” U.S. Patent Application 63/722,934, filed Nov. 20, 2024, entitled “Sprayer PWM Nozzle Valve Pressure Drop Mitigation,” U.S. Patent Application 63/723,400, filed Nov. 21, 2024, entitled “Systems, Methods and Devices for Increasing Machine Operating Range Using PWM and Dynamic Pressure Range Control,” U.S. Patent Application 63/727,579, filed Dec. 3, 2024, entitled “Smart Shift for Automatic AB Line Adjustment in Agricultural Operations and Related Devices and Methods,” U.S. Patent Application 63/752,279, filed Jan. 31, 2025, entitled “System and Automatic Adjustment to Target Pressure and Related Devices and Methods,” U.S. Patent Application 63/752,341, filed Jan. 31, 2025, entitled “Harvester Liquid Application System, Devices, and Methods,” U.S. Patent Application 63/753,258, filed Feb. 3, 2025, entitled “Agricultural Navigation Methods, Devices, and Systems,” U.S. Patent Application 63/753,201, filed Feb. 3, 2025, entitled “Agricultural Mapping and Related Devices, Systems, and Methods” U.S. Patent Application 63/755,675, filed Feb. 7, 2025, entitled “Remote Assistance for Agricultural Display Methods and Related Devices and Systems,” U.S. Patent Application 63/757,242, filed Feb. 11, 2025, entitled “Seed Meter,” U.S. Patent Application 63/757,434, filed Feb. 12, 2025, entitled “Grain Fill Sensor,” U.S. Patent Application 63/760,907, filed Feb. 20, 2025, entitled Agricultural Yield Monitoring and Estimation Devices, Systems, and Methods,” U.S. Patent Application 63/816,284, filed Jun. 2, 2025, entitled “Agricultural Guidance and Navigation Systems, Methods, and Devices,” U.S. Patent Application 63/817,692, filed Jun. 4, 2025, entitled “Intelligent Steering System for Sprayers and Tractors in Standing Crops,” U.S. Patent Application 63/818,248, filed Jun. 5, 2025, entitled “Devices, Systems, and Methods for Determining Implement Pose,” each of which is incorporated herein by reference.

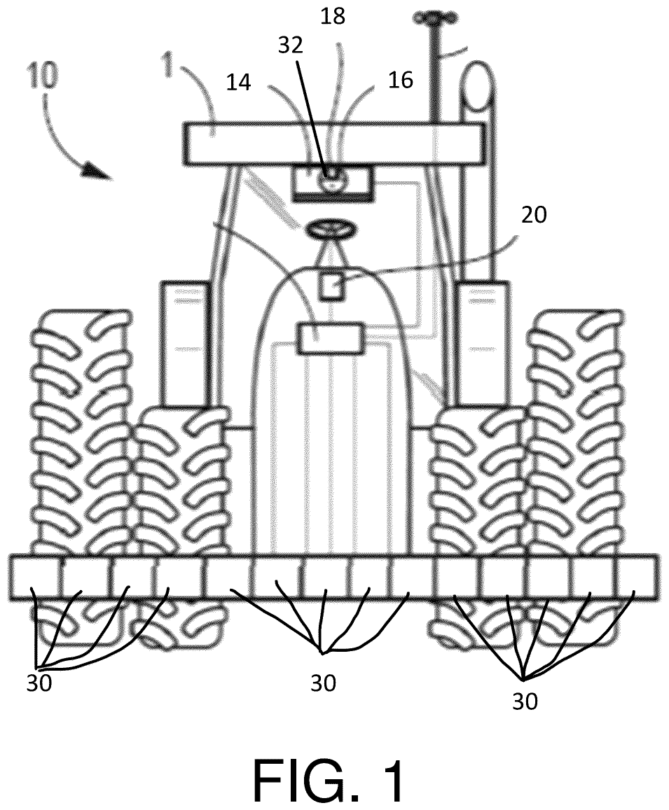

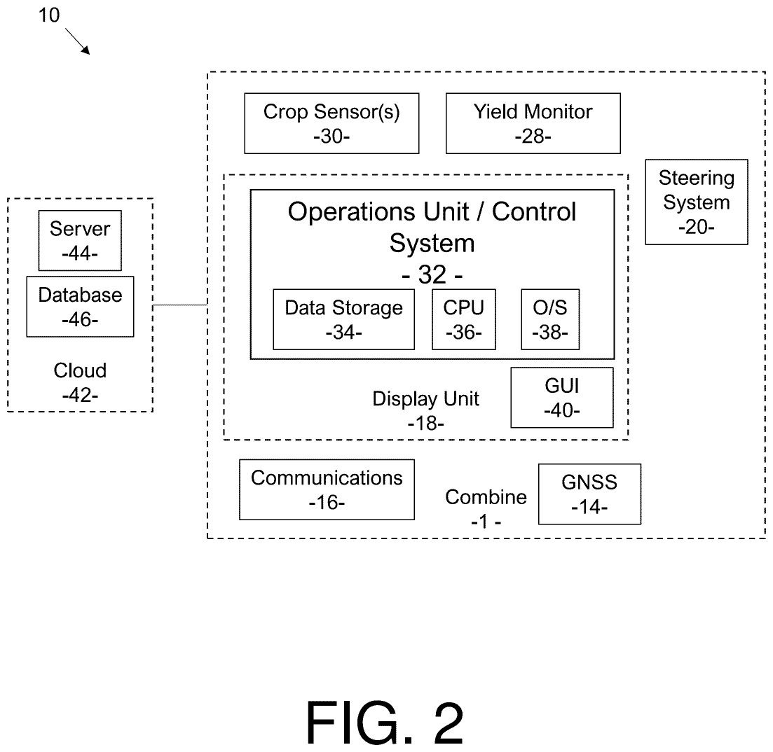

Turning to the figures in more detail, in various implementations the integrated navigation and steering system 10 is implemented on a combine 1 or similar vehicle 1, as would be understood, shown in FIG. 1. In various implementations, the system 10 includes a GNSS or GPS receiver 14, one or more crop sensors 30 in operational communication with a vehicle system display 18, such as the InCommand® display from Ag Leader®, and an operations unit 32, as is shown in greater detail in FIG. 2. The system 10 optionally comprises various additional sensors, monitors and the like, as would be appreciated by those of skill in the art and as disclosed in various of the incorporated references.

The system 10 further includes an automatic and/or assisted steering system 20. As would be understood, various automatic and/or assisted steering systems 20 are configured to take inputs from an operations unit 32 navigate a vehicle through a field. Various steering systems 20 may manually and/or electronically manipulate the systems on board a harvest vehicle 1 to effectuate automatic and/or assisted steering, as would be appreciated by those of skill in the art. In various implementations, the automatic/assisted steering system 20 allows for autonomous navigation.

Continuing with FIGS. 1 and 2, in various implementations, the system 10, optionally integrated within the display 18, is an operations unit 32 in operational communication with data link 16 (also referred to herein as a communications component 16). It is generally understood that these components may optionally be housed within the display unit 18 and that the representation of FIG. 2 is merely exemplary.

In certain implementations, the operations unit 32 is also configured for the sending and receiving of data for storage and processing, such as to the cloud 42, a remote server 44, database 46, and/or other cloud computing components readily understood in the art. Such connections by the operations unit 32, can be made wirelessly via understood internet and/or cellular technologies such as Bluetooth, Wi-Fi, LTE, 3G, 4G, or 5G connections, and the like. It is understood that in certain implementations, the operations unit 32 and/or cloud 42 component may comprise encryption or other data privacy components such as hardware, software, and/or firmware security aspects.

Continuing with FIG. 2, the operations unit 32, according to certain implementations, further has one or more optional processing and computing components, such as data storage 34, a CPU or processor 36, an operating system (“O/S”) 38, and other computing components necessary for implementing the various technologies disclosed herein. It is appreciated that the various optional system components are in operational communication with one another via wired or wireless connections and are configured to perform the processes and execute the commands described herein. As would be understood, each of these components can be located optionally at various locations around the vehicle or elsewhere, such as in the cloud 42 and accessible by a wireless or cellular connection.

In various implementations, this connectivity means that an operator, enterprise manager, and/or other third party is able to receive notifications such as adjustment prompts and confirmation screens on their mobile devices or via another access point. In certain implementations, these individuals can review the various data collected or recorded by the system 10 and make adjustments, comments, and/or observations in real-time or near real-time, as would be readily appreciated.

As shown in FIGS. 1 and 2, the system 10 includes at least one crop sensor 30 that is in operational communication with the system 10 and operations unit 32 via the communications component or data link 16. It is understood that in certain implementations, the crop sensor(s) 30 are in direct operational communication with the operations unit 32 and/or steering system 20, and that it is calibrated to utilize raw data values generated by those crop sensors 30 to perform various steering related tasks as will be discussed in further detailed herein. Various exemplary crop sensors 30 are discussed in various of the incorporated references including: U.S. Pat. Nos. 11,064,653, 11,297,768, U.S. patent application Ser. No. 17/226,002, U.S. patent application Ser. No. 17,013,037, and U.S. patent application Ser. No. 18/087,413 among others.

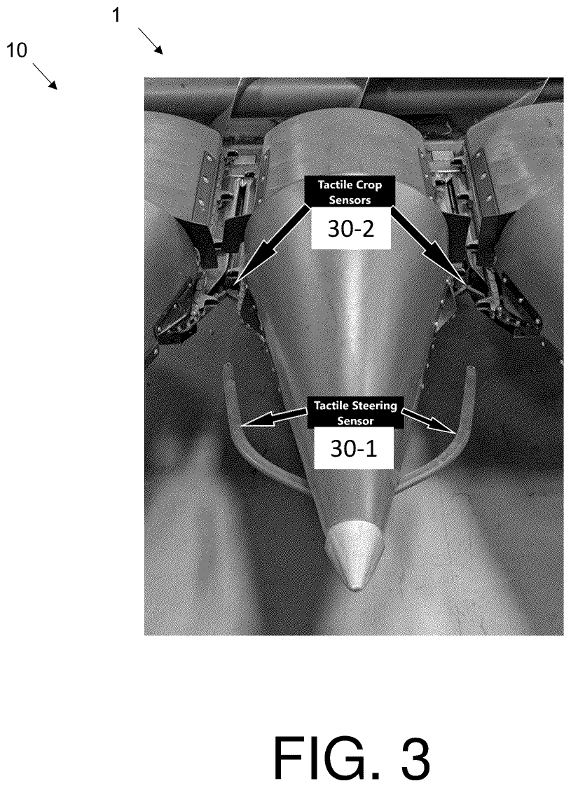

As can be seen in FIG. 3, the harvester 1 may include many types of crop sensors 30, including, among others, tactile steering sensors 30-1, tactile crop sensors 30-2, vision sensors, radar sensors, resilient member sensors, LiDAR sensor, and others that would be appreciated by those of skill in the art. Shown in FIG. 3 is a harvester 1 having two different crop sensors 30, a tactile steering sensor 30-1 configured to sense the position of the harvester relative to crop rows and a tactile crop sensor 30-2 configured to detect and verify crop presence in the rows. Various alternative configurations are possible include one, two, three or more types of crop sensors 30 on the row units. In various implementations, crop sensors 30 are disposed on each row unit of the crop header, while in other implementations less than all of the row units include crop sensors 30.

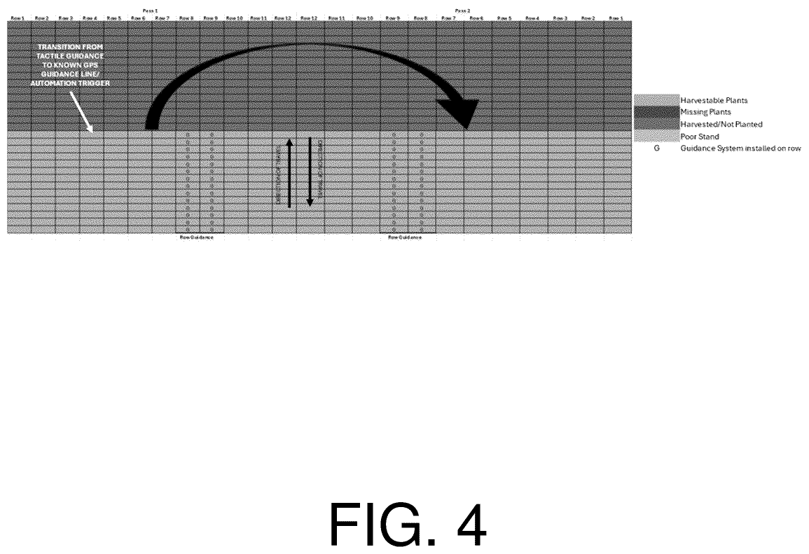

FIG. 4 shows an exemplary map of a field 50 where the integrated steering system 10 executes a trigger from crop sensor 30 based steering to GPS 14 guidance based steering. In these and other implementations, when the harvester 1 comes to the end of a pass and enters a previously harvested/not planted area (brown area), the crop sensor 30 system longer detects stalks and triggers the steering system 10 to switch from crop sensor 30 based steering to GPS 14 guidance based steering. Additionally or alternatively, the system 10 may be used in conjunction with AutoSwath functionality (programs for detecting and placing section boundaries) and/or other programmed/mapped field boundaries to trigger end-of-pass automated turns (such as TurnPath™ from Ag Leader). Further, in certain implementations, the system 10 may also issue commands to the harvester 1 and sub systems thereof to automatically raise the header or any other desired operation, as would be understood.

Further, the integrated steering system 10 may include a start of pass trigger. That is, triggering a change from GPS 14 based guidance in previously harvested or unplanted areas (brown area) to crop sensor 30 based steering when actively harvesting plants (green area). As would be understood, when the harvester 1 enters the next pass after a turn (or the first pass in a field), the tactile steering system (crop sensor 30 based steering) is engaged. In various implementations, the trigger causes the system 10 to auto engages crop sensor 30 based steering when the crop sensor 30 detects stalks. Alternatively, the system 10 may prompt a user to confirm the trigger and change the steering/guidance system. In various implementations, a user may be able to override the system 10 triggers and force use of crop sensor 30 based steering, GPS 14 guidance, or other similar system for automatic/assisted steering.

As would be appreciated the start/end of pass trigger may prevent situations where the crop sensor 30 based steering system is engaged when not actively harvesting/detecting stalks. When the crop sensor 30 is no longer detecting stalks, the system 10 loses the ability to detect a row accurately which can result in the combine driving off the row. In typical harvesters 1 multiple rows are simultaneously harvesting, while a tactile guidance system is utilizing one or two rows of crop sensing to steer the harvester 1 down the row. A tactile guidance system relies on healthy standing crop in the rows it is installed on to steer accurately. When implementing the system 10, when the tactile guidance system (crop sensor 30) does not detect crops for guidance the system 10 automatically engaged GPS 14 based guidance.

Turning now to FG. 5, in various implementations, if crop material is equally present across the harvester swath, the tactile (crop sensor 30) steering system would be the selected steering method over a known GPS 14 guidance line to steer along the row.

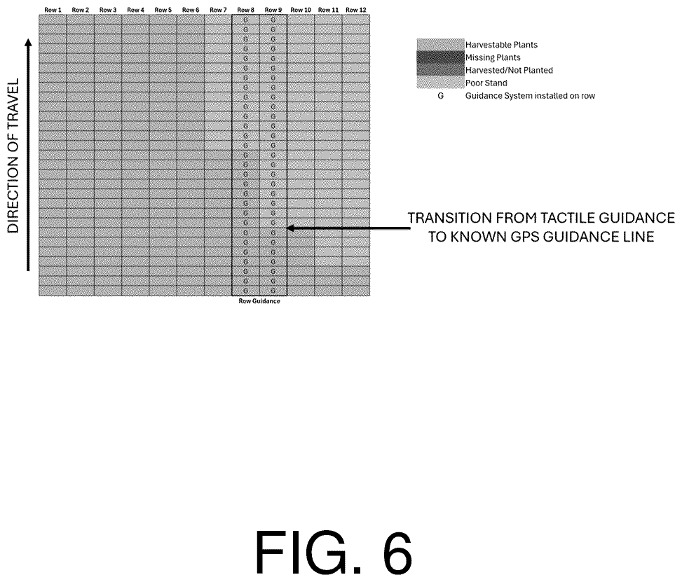

When the harvester 1 transitions from harvesting in healthy standing crop (all rows of the head) to operating in a region of the field where the planted crop had emerged poorly or underproduced (e.g., wet spot in field, pest/disease damage, wind damage, etc.), the crop sensor 30 may detect either no stalks or stalks below a threshold (known fixed value or as compared to adjacent rows), as shown in FIG. 6. When entering a poor stand area, the system 10 may trigger the use of GPS 14 based guidance or other known guidance paths. Various further implementations may also be used in conjunction with guidance line generation systems such as SmartPath™ from Ag Leader where upon triggering a change from crop sensor 30 based steering to use of a generated guidance line the guidance line may be generated from a previous (adjacent) tactile guidance pass.

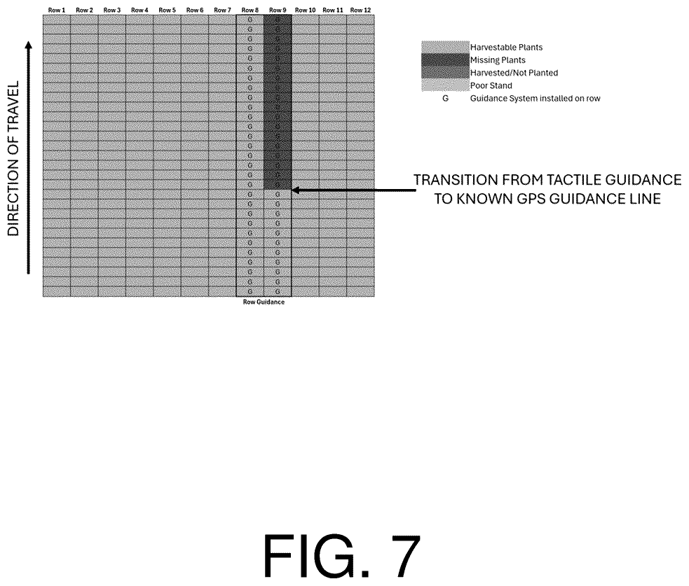

In various further implementations, when the harvester 1 is harvesting in healthy standing crop (using crop sensor 30 based steering) and enters an area with one, or multiple, rows dropped out (shown in red in FIG. 7) (i.e. row run over in previous operation, planter issue caused seed to not be planted, etc) the system 10 may trigger the use of GPS 14 based guidance or other known guidance paths. Various further implementations may also be used in conjunction with SmartPath™ from Ag Leader triggering a change from crop sensor 30 based steering to use of a generated guidance line derived from a previous (adjacent) tactile guidance pass.

FIG. 7 shows an example where the harvester 1 is harvesting in healthy standing crop then transitions into a region where only a partial section of the head was being utilized due to field shape or harvesting patterns that have resulted in crop already being harvested or never planted in those regions (e.g., waterway, terrace, field boundary, etc.). In this example, if tactile guidance system (crop sensor 20 steering) is on a row not being utilized the system 10 would trigger the transition from the tactile guidance to a known guidance line (GPS 14 based guidance) or SmartPath™ based previous tactile guidance pass, as discussed above.

The system 10 allows the operator to focus making sure the combine and harvest operations are running smoothly rather than steering or correcting the combine. Further, the system 10 may reduce operator fatigue. Still further, the system 10 may make the operator/operations more efficient, reducing harvest time.

The system 10 incorporates steering based on the actual location of the crop with the benefits of GPS location based steering (end-row/headland turns, utilize previous pass to generate current pass, etc.). The system 10 also reduces operator fatigue by automatically steering the combine where the crop is and then automatically turns the combine around for the next pass where no crop exists. By automatically turning around and lining the combine up for the next pass, the operator no longer needs to count rows and steer to where the crop is then engage steering. The operator would only need to monitor the turn and not actually perform it or think about where to enter.

The system 10 may also mitigates the occurrence of a tactile guidance system deficiencies resulting in the harvester being guided off of the intended rows.

In various implementations, the system 10 may be used in other applications in addition to harvesting, including side-dressing, spraying, etc.

Although the disclosure has been described with references to various embodiments, persons skilled in the art will recognize that changes may be made in form and detail without departing from the spirit and scope of this disclosure.

What is claimed is:

1. An agricultural steering system comprising:
(a) a tactile steering system comprising at least one crop sensor configured to command steering of an agricultural vehicle based upon the location of stalks;
(b) a GPS guidance system comprising at least one GPS receiver configured to command steering of the agricultural vehicle along guidance paths; and
(c) a processor configured for selectively using either the tactile steering system and the GPS guidance system based on one or more triggers.

2. The agricultural steering system of claim 1, wherein the one or more triggers include detection of stalks entering the header by the at least one crop sensor, completing a pass, approaching/crossing a field boundary, and entering an already harvested area.

3. The agricultural steering system of claim 1, wherein the system is configured to use the tactile steering system during active harvesting of crops and use the GPS guidance system when not actively harvesting crops.

4. The agricultural steering system of claim 1, wherein the processor is configured to automatically switch between the tactile steering system and the GPS guidance system upon activation of the one or more triggers.

5. The agricultural steering system of claim 1, further comprising an automatic steering system wherein the processor is configured to command the automatic steering system.

6. The agricultural steering system of claim 1, wherein the at least one crop sensor is one or more of a tactile steering sensor, a tactile crop sensor, a vision sensor, a radar sensor, a resilient member sensor, and a LIDAR sensor.

7. The agricultural steering system of claim 6, wherein the at least one crop sensor is a tactile steering sensor.

8. The agricultural steering system of claim 1, wherein the one or more triggers is active harvesting and wherein the system uses the tactile steering system during active harvesting and the GPS guidance based system when not actively harvesting.

9. The agricultural steering system of claim 8, wherein active harvesting is determined by the at least one crop sensor sensing stalks entering the agricultural vehicle.

10. A system for automatic agricultural steering and navigation comprising:
(a) at least one row unit for a harvester, comprising a first crop sensor;
(b) a global positioning system (GPS) receiver configured to be disposed on the harvester;
(c) an operations unit comprising a processor in communication with the first crop sensor and the GPS receiver, and
(d) an assisted steering system configured to command a vehicle to navigate a field,
wherein the operations unit is configured to determine use of navigation based on inputs from the first crop sensor or navigation based on one or more guidance paths generated with inputs from the GPS receiver.

11. The system of claim 10, wherein the harvester comprises a plurality of row units, each of the plurality of row units comprising the first crop sensor.

12. The system of claim 10, wherein the first crop sensor is one or more of a tactile steering sensor, a tactile crop sensor, a vision sensor, a radar sensor, a resilient member sensor, and a LIDAR sensor.

13. The system of claim 10, wherein the first crop sensor is a tactile steering sensor.

14. The system of claim 10, further comprising a second crop sensor disposed on the at least one row unit wherein the second crop sensor is a tactile crop sensor.

15. The system of claim 10, wherein the assisted steering system provides for autonomous navigation.

16. The system of claim 10, wherein the operations used evaluates one or more triggers for switching between navigation based on inputs from the first crop sensor or navigation based on one or more guidance paths generated with inputs from the GPS receiver.

17. The system of claim 16, wherein the one or more triggers include detection of stalks entering the header by the at least one crop sensor, completing a pass, approaching/crossing a field boundary, and entering an already harvested area

18. A method for agricultural navigation comprising:
inputting a signal from at least one sensor disposed on a harvester the signal indicative of a relative position of the harvester within a row;
obtaining a position from a GPS receiver on the harvester;
generating a set of GPS based guidance paths; and
selecting a first navigation mode based on the signal from the at least one sensor or a second navigation mode based on the GPS based guidance paths,
wherein a automatic steering system can switch between the first navigation mode or the second navigation mode is based on one or more triggers.

19. The method of claim 18, wherein the one or more triggers include detection of stalks entering the header by the at least one sensor, completing a pass, approaching/crossing a field boundary, and entering an already harvested area.

20. The method of claim 19, wherein the at least one sensor is one or more of a tactile steering sensor, a tactile crop sensor, a vision sensor, a radar sensor, a resilient member sensor, and a LiDAR sensor.
